(19) United States
(12) Patent Application Publication
(10) Pub. No.: US 2024/0268420 A1
(43) Pub. Date: Aug. 15, 2024

(54) SYSTEMS AND METHODS FOR HIGH-pH TREATMENT OF FOODSTUFFS AND OTHER SUBSTRATES

(71) Applicants: Tyson Foods, Inc., Springdale, AR (US); CMS TECHNOLOGY, LLC, Chicago, IL (US)

(72) Inventors: Eddie Lamar JONES, Greenwood, AR (US); John MECCIA, Ringoes, NJ (US); Francis DAUTREUIL, Seabrook, TX (US); Ingrid COLE, Ringoes, NJ (US); Brandon BENISH, Rogers, AR (US); Ty BAUBLITS, Springdale, AR (US)

(73) Assignees: Tyson Foods, Inc., Springdale, AR (US); CMS TECHNOLOGY, LLC, Chicago, IL (US)

(21) Appl. No.: 18/609,521

(22) Filed: Mar. 19, 2024

Related U.S. Application Data
(62) Division of application No. 16/959,048, filed on Jun. 29, 2020.
(60) Provisional application No. 62/611,741, filed on Dec. 29, 2017.

(51) Int. Cl. A23L 3/358; A22C 17/08; A22C 21/00; A22C 25/02; A23B 4/20; A23B 4/24; A23B 4/26; A23L 3/3499; A23L 3/3589

(52) U.S. Cl. CPC A23L 3/358; A22C 17/08; A22C 21/0061; A22C 25/02; A23B 4/20; A23B 4/24; A23B 4/26; A23L 3/3499; A23L 3/3589; A23V 2002/00

(57) ABSTRACT

The present disclosure provides systems and methods for treatment of substrates—such as foodstuffs—with a high pH composition and an oxidizer. These systems and methods give rise to enhanced disinfection performance.

### RELATED APPLICATION

This application is a divisional of U.S. application Ser. No. 16/959,048, filed on Jun. 29, 2020, which is a National Stage Entry of International Application No. PCT/US2018/067918, filed on Dec. 28, 2018, which claims the benefit of U.S. Provisional Application No. 62/611,741, filed on Dec. 29, 2017, the entirety of each of which are incorporated herein by reference for any and all purposes.

### TECHNICAL FIELD

The present disclosure relates to the field of foodstuff treatment and to the field of blending and communication of chemical agents.

### BACKGROUND

Many existing foodstuff treatment applications (e.g., poultry treatment processes) are based on contacting a foodstuff with peroxyacetic acid (“PAA”) or other oxidizing agent in a treatment location such as a dip tank, a spray area, and the like. These approaches typically involve contacting the foodstuff for a period of time (often a comparatively long period of time) with a comparatively high concentration of PAA and/or other agent so as to sufficiently disinfect the foodstuff.

PAA and other such agents, however, are subject to regulations that govern the permissible airborne levels of the agent. In addition, even when present below their maximum allowable levels, PAA and other such agents may also present an unpleasant smell to users. Further, PAA and other agents can be costly, and comparatively high concentrations of the agents can present an economic burden to their users. Accordingly, there is a long-felt need in the art for foodstuff treatment approaches that exhibit improved effectiveness and/or utilize reduced levels of PAA and similar agents.

### SUMMARY

In meeting the long-felt needs describe above, the present disclosure first provides treatment methods, comprising: in a treatment process, (a) contacting a substrate at an application region with a basic fluid having a pH of at least about 9 and with an oxidizer, or (b) contacting a substrate at an application region with a composition that comprises an oxidizer, the composition having a pH of at least about 9.

The present disclosure also provides systems, comprising: an application region configured to receive a substrate for treatment; and (i) a first inlet configured to deliver to the application region a composition having a pH of at least about 9 and an oxidizer, or (ii) a first inlet configured to deliver to the application region a basic fluid having a pH of at least about 9 and a second inlet configured to deliver to an oxidizer to the application region.

Further provided are systems, comprising: a first application region configured to receive a substrate for treatment; a first inlet configured to deliver to the first application region a composition having a pH of at least about 9; a second application configured to receive the substrate for treatment; and a second inlet configured to deliver an oxidizer to the second application region.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 provides a non-limiting embodiment of the disclosed technology;

FIG. 2 provides an alternative embodiment of the disclosed technology;

FIG. 3 provides a further embodiment of the disclosure technology;

FIG. 4 provides whole bird carcass rinse (“WBCR”) salmonella percentages for whole birds (chickens) and chicken skin processed according to the present disclosure;

FIG. 5 provides pre- and post-chiller bacterial counts for whole bird and skin samples processed at pH 8.2/40 ppm PAA on a first day of testing;

FIG. 6 provides pre- and post-chiller bacterial counts for whole bird and skin samples processed at pH 11.2/40 ppm PAA on a first day of testing;

FIG. 7 provides pre- and post-chiller bacterial counts for whole bird and skin samples processed at pH 8.2/40 ppm PAA on a second day of testing;

FIG. 8 provides pre- and post-chiller bacterial counts for whole bird and skin samples processed at pH 11.2/40 ppm PAA on a second day of testing;

FIG. 9 provides an image of a droplet according to sample A (described elsewhere herein) on a chicken skin surface;

FIG. 10 provides an image of a droplet according to sample B (described elsewhere herein) on a chicken skin surface; and

FIG. 11 provides an image of a droplet according to sample C (described elsewhere herein) on a chicken skin surface.

### DETAILED DESCRIPTION OF ILLUSTRATIVE EMBODIMENTS

The present invention can be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges includes each and every value within that range. Any documents cited herein are incorporated herein by reference in their entireties for any and all purposes.

### Terms

It is also to be understood that the terminology used herein is for the purpose of describing particular aspects only and is not intended to be limiting. As used in the specification and in the claims, the term “comprising” may include the embodiments “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more polycarbonates.

Ranges can be expressed herein as from one particular value, and/or to another particular value. When such a range is expressed, another aspect includes from the one particular value and/or to the other particular value. For example, a range of “1 to 10” includes all intermediate values, e.g., 3, 5.56, and 7.3. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated+/−10% a variation unless otherwise indicated or inferred. For example, “about 10” encompasses the range from 9 to 11, including 10. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally substituted alkyl” means that the alkyl group can or cannot be substituted and that the description includes both substituted and unsubstituted alkyl groups.

Disclosed are the components useful in preparing the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary.

For example, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (“wt %”) of a component, unless specifically stated to the contrary, is based on the total weight of the formulation or composition in which the component is included. For example if a particular element or component in a composition or article is said to have 8% by weight, it is understood that this percentage is relative to a total compositional percentage of 100% by weight. Molecular weights, where given, are understood to be on a polystyrene basis.

Compounds are described using standard nomenclature. For example, any position not substituted by any indicated group is understood to have its valence filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this invention belongs.

### Overview

The chemical agent blending and communication systems disclosed herein can be utilized in a wide array of industries and applications, in particular those applications that require controlled dispensing of chemicals in a manner that can, inter alia, (i) dramatically reduce ambient chemical in the local environment that can be adverse to employee conditions and health (e.g., excessive amounts without the system can cause pungent or noxious odors that make for difficult working conditions—often for many hours on a daily basis, excessive amounts that can result in irritation or exceeding certain government limits such as those imposed by NIOSH), (ii) improve disinfection process effectiveness by increasing the effectiveness of active disinfection agents.

As described, existing technologies can suffer from poor spreading and/or penetration of active agents. By utilizing a comparatively high-pH treatment, the disclosed technology enhances the spreading and/or penetration of active agents so as to reduce cycle times, increase effectiveness, and even reduce the amount of active agent needed.

A user can configure a system to maintain a particular range/level of one or more agents in fluid supplied to the use location, such as a treatment module. Exemplary ranges for certain illustrative agents can be found at, for example:
Chemical Priority Lists for Acute Exposure Guideline Levels (AEGLs)—First List of AEGL Priority Chemicals for Guideline Development, United States EPA, updated May 16, 2016).
Chemical Priority Lists for Acute Exposure Guideline Levels (AEGLs)—Second List of AEGL Priority Chemicals for Guideline Development, United States EPA, updated May 16, 2016).
Chemical Listing and Documentation of Revised IDLH Values (as of Mar. 1, 1995), United States CDC/NIOSH (Dec. 4, 2014).
http://www.fsis.usda.gov/wps/wcm/connect/24346cbd-ad28-4223-8db1-55f067ce3879/antimicrobial.pdf? MOD=AJPERES (United States FDA)
United States NIOSH listing found at http://www.cdc.gov/niosh/idlh/intridl4.html.
USDA Food Safety and Inspection Service (FSIS) Directive 7120.1

The disclosed technology can be used with any of the chemical agents listed in the foregoing and to achieve any range of the foregoing agents, including the ranges prescribed above. (All of the foregoing references are incorporated by reference herein in their entireties for any and all purposes.)

### Example Process Flow

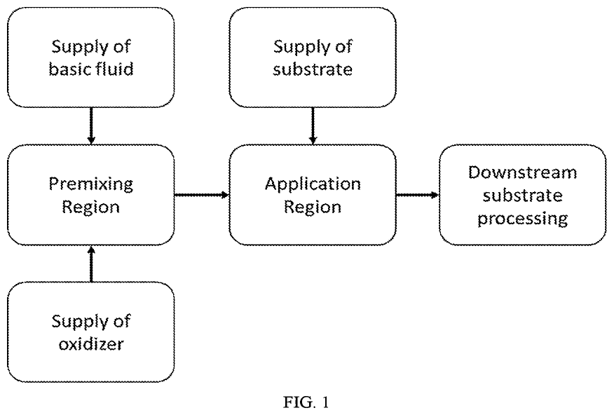

FIG. 1 provides an exemplary embodiment of the disclosed technology. As shown, a supply of a basic fluid (e.g., NaOH, KOH) and a supply of an oxidizer can be supplied to a premixing region. At the premixing region, the basic fluid and the oxidizer can be mixed, e.g., via stirrer, baffle, turbulent flow, or by other methods known to those of ordinary skill in the art. It should be understood that the premixing region is optional, as the basic fluid and oxidizer can also both be supplied to the application region. In some embodiments, the basic fluid and oxidizer can be introduced separately (e.g., via separate inlets) to the application region. An application region can itself include one or more mixing modalities so as to facilitate mixing of the basic fluid and the oxidizer.

A supply of substrate (e.g., whole birds, poultry parts) can be provided to the application region. The supplied substrate can then be contacted with the basic fluid and oxidizer. Following that contacting, the substrate can be subjected to downstream processing.

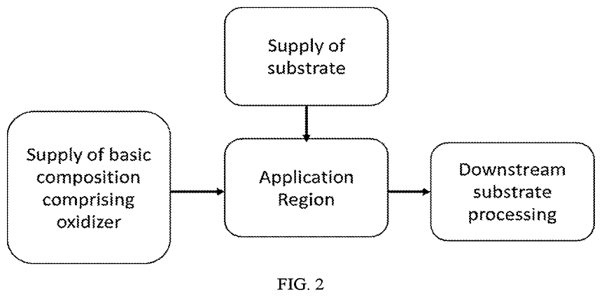

FIG. 2 provides another embodiment of the disclosed technology. As shown in FIG. 2, a supply of a basic composition that includes an oxidizer can be supplied to an application region. A supply of substrate (e.g., whole birds, poultry parts) can be provided to the application region. The supplied substrate can then be contacted with the composition. Following that contacting, the substrate can be subjected to downstream processing.

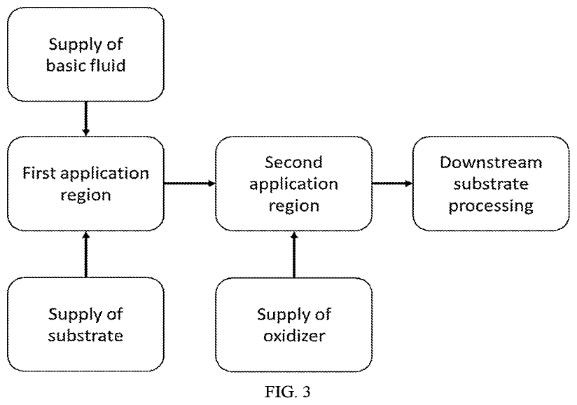

FIG. 3 provides a further embodiment of the disclosed technology. As shown in FIG. 3, substrate can be contacted with a basic fluid at a first application region. The substrate can then be contacted with oxidizer at a second application region. Following that, the substrate can be subjected to downstream processing.

It should be understood that in some embodiments, the substrate is contacted simultaneously with the basic fluid and the oxidizer. (As one such example, the basic fluid and oxidizer can be mixed together.) In some embodiments, the substrate is first contacted with the basic fluid, followed by contact with the oxidizer. In other embodiments, the substrate is first contacted with the oxidizer, followed by contact with the basic fluid.

### Exemplary Results

The following testing and results are exemplary only.

### 1. Basic pH Testing

Table 1 below provides exemplary results from the disclosed technology.

TABLE 1
Exemplary Results

| Prechiller/Chiller | | |
|---|---|---|
| pH | PAA (ppm) | APC log reduction |
| 10.2 | 36 | 2.01 |
| 10 | 24 | 1.11 |
| 10.7 | 36 | 3.14 |
| 10 | 48 | 2.57 |

To collect the data above, a basic solution (Sodium hydroxide) and PAA both were supplied via separate inlet streams to a single application point. The proportions of the foregoing were varied to achieve the concentrations/pH of the compositions listed in the table. The concentration and pH in Table 1 above are values for the composition in the application region.

A sample of the treated water was taken from the center of the chiller. The temperature was maintained between 37-40 deg. F., and the duration of treatment was 60 min. The results above represent the average of 5 samples, and samples were taken of whole birds as they exited the chiller.

The Aerobic Plate Count (APC) is used as an indicator of bacterial populations on a sample; it can also be known as the aerobic colony count, the standard plate count, the Mesophilic count or the Total Plate Count.

A whole bird carcass can be aseptically collected at each designated collection site using sterile gloves or an inverted bag, and excess liquid will be allowed to drain from each carcass before placing it in the shaker bag. This can be performed according to the FSQA Laboratory Manual, Chapter 13, Mega Reg Microbiological Testing. Rinsates can be analyzed quantitatively for APC, e.g., utilizing AOAC 966.23.

As shown in Table 1 above, at a constant pH of 10, increasing PAA concentration from 24 to 48 ppm resulted in a log reduction of bacterial count from 1.11 to 2.57. Holding PAA concentration constant at 36 ppm and increasing pH from 10.2 to 10.7 resulted in a log reduction of bacterial count from 2.01 to 3.14. Thus, one can improve the effectiveness of a given level of PAA (or other oxidizer) by increasing the ambient pH. Similarly, at a given level of PAA, one can also increase the effectiveness of a disinfection process by raising the pH. In this way, one can obtain a desired level of disinfection without exceeding a certain level of vapor (e.g., PAA vapor) by raising the pH, as a higher pH acts—surprisingly—to enhance the effectiveness of other agents that can be present.

### 2. Chilled pH Comparison Testing

Testing was performed on treatments in chillers at different pH levels to determine microbial reduction on WBCR and microbial reduction in deep tissue. The testing included the following conditions:

$$PAA - Target 40 ppm / pH = 8.2$$

$$PAA - Target 40 ppm / pH = 11.2$$

2a. Chilled pH Comparison Testing Conditions

Whole chickens without giblets (including the whole breast, two wings, and two legs; head, feet and internal organs are removed) (“WOG”s) were collected from a shackle line and sampled as follows:
Select a WOG from shackle line (without removing that selected WOG), then count the next four WOGs and remove the fifth WOG. This method was used to prevent bias in the selection process.
Place removed WOGs into sterile stomacher bags and rinse with buffered peptone water solution according to procedures set forth in the USDA FSIS's Laboratory Guidebook MLG 3.02.
Aseptically transfer 100 ml of rinsate into sterile uniquely labelled containers and store at a temperature of 38-40° F.
Samples were then analyzed for: APC/TPC, EB, Salmonella and Campylobacter.
   2b. Chilled pH Comparison Testing Experimental Procedures

Testing was be repeated over a two-day period as follows:

i. Microbial Reduction on WBCR

### Pre-Chill

Remove (10) WOG's before entering the pre-chiller and rinse according to the procedures identified above. The temperature was between about 32 and 37 deg. F., and the dwell time was from about 15 to about 20 minutes.

### Post-Chill

Remove (10) WOG's from chiller exit. The temperature was between about 32 and about 37 deg. F., and the dwell time was from about 60 to about 80 minutes. When possible, samples were collected before the rehang belt. If not, sample was removed from rehang belt at point of entry onto belt. Due to the randomness of the WOG's exiting the chiller and the complexity of retrieving these WOG's, A WOG was randomly retrieved prior to rehang and at least 10 birds were spaced between samples. Then each WOG was allowed to drain of excess fluid for approximately 1 minute. Samples were then rinsed according to the procedures identified above.

ii. Microbial Reduction in Deep Tissue

### Pre-Chill

Remove 5 WOG's pre-chill, then remove as much skin and fatty tissue as possible from carcass. Place skin into sterile bag and label. Samples were then macerated and analyzed for aerobic plate count (“APC”), total plate count (“TPC”), enterobacteriaceae (“EB”), salmonella (“SLM”, in some instances) and campylobacter (“Campy”, in some instances).

### Post-Chill

Remove 5 WOG's post-chill (as described in previous section), and then carefully remove as much skin and fatty tissue as possible from carcasse. Place skin into sterile bag and label. Samples were macerated and analyzed for APC/TPC, EB, Salmonella and Campylobacter.

2c. Results Summary

The results of the foregoing tests can be summarized as follows:
High pH (i.e., pH 11.2) treatment showed 100% reduction in Salmonella on whole bird rinses. High pH also showed 100% reduction of Campylobacter on whole bird rinses.
High pH treatment had appx. 0.5-1.0 greater log reductions on the skin of the whole bird in APC and EB, versus low pH treatments.
High pH had+1.0 log greater reduction in Campylobacter on the skin of the whole bird, versus low pH treatments.

### Microbial Reduction on WB and Deep Tissue

### Day 1: Microbial Reduction Comparison:

TABLE 2
Microbial reduction for high- and low-pH
treatments for whole birds and for chicken skin.

| | | Microbial Reduction-WB | | | | Microbial Reduction-Skin | | | |
|---|---|---|---|---|---|---|---|---|---|
| PAA | pH | APC | EB | Campy * | SLM | APC | EB | Campy | SLM |
| 40 | 8.2 | 1.82 | 1.62 | 2.32 | 83% | 0.76 | 0.64 | 0.15 | 56% |
| 40 | 11.2 | 0.89 | 0.96 | 1.59 | 100% | 0.78 | 0.90 | 0.99 | 50% |

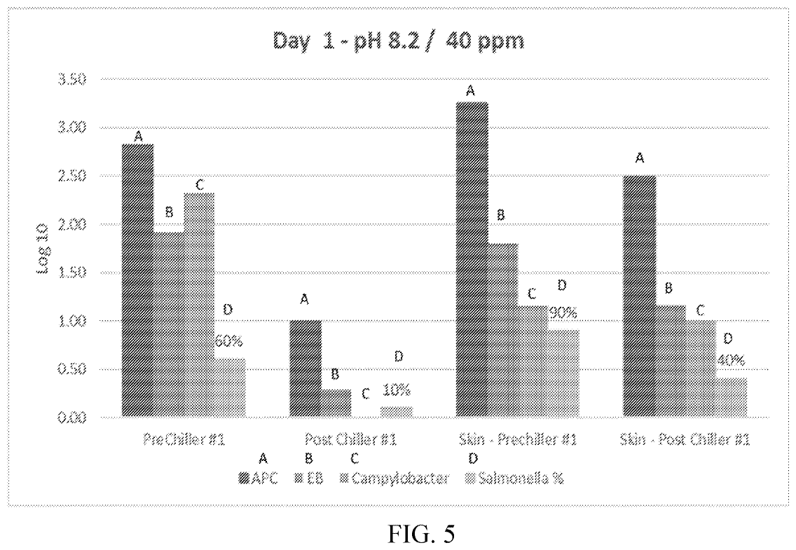

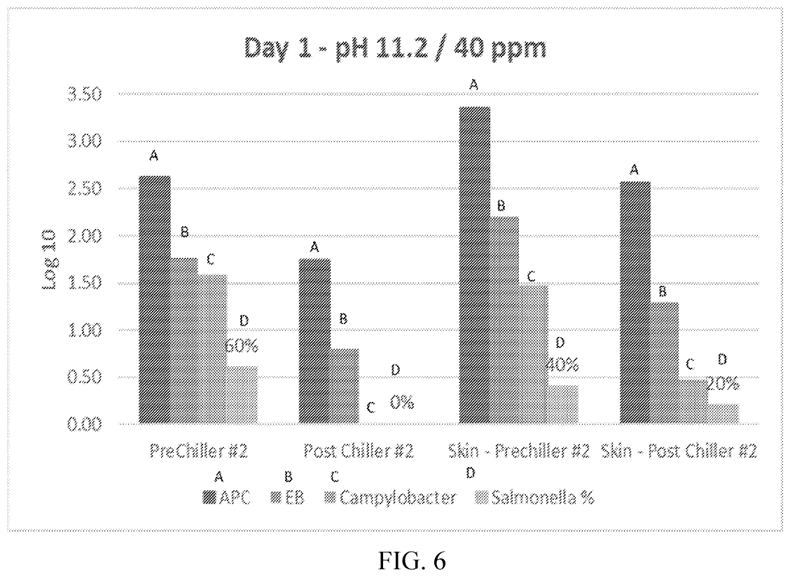

As shown, all Campylobacter was eliminated on WB rinses. (The reductions shown in Table 2 are also shown in FIGS. 5-6.)

### Day 2: Microbial Reduction Comparison

TABLE 3
Microbial reduction: Microbial reduction for high- and
low-pH treatments for whole birds and for chicken skin

| | | Microbial Reduction-WB | | | | Microbial Reduction-Skin | | | |
|---|---|---|---|---|---|---|---|---|---|
| PAA | pH | APC | EB | Campy* | SLM | APC | EB | Campy | SLM |
| 40 | 8.2 | 1.34 | 1.04 | 1.59 | 0% | 0.26 | 0.46 | 0.46 | 0% |
| 40 | 11.2 | 0.85 | 1.52 | 1.28 | 100% | 0.46 | 0.85 | 1.35 | 83% |

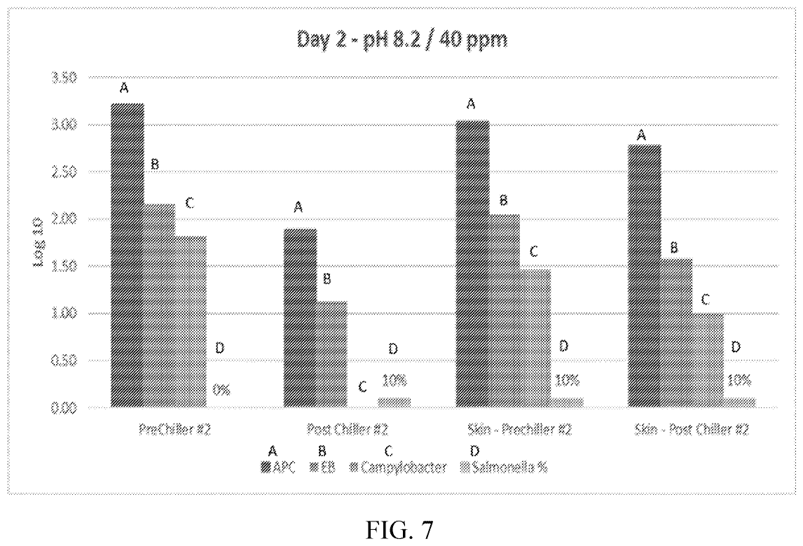

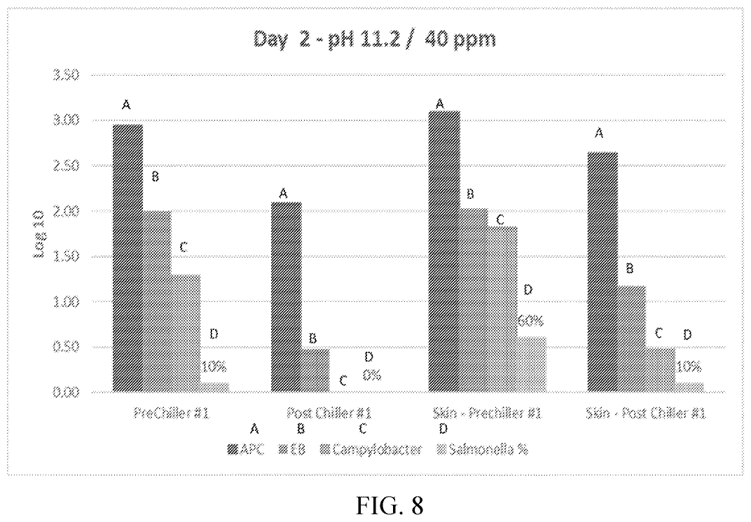

As shown, all Campylobacter was eliminated on WB rinse. (The reductions shown in Table 2 are also shown in FIGS. 7-8.)

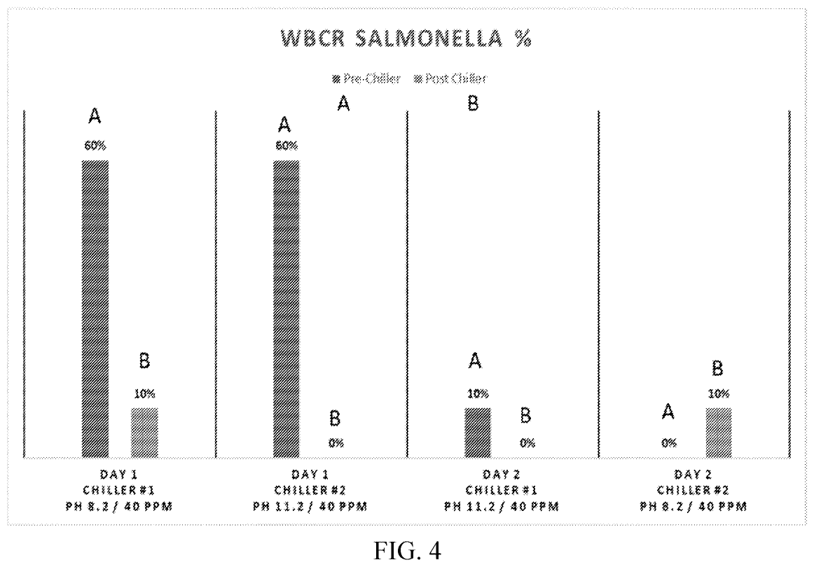

As shown in FIG. 4 (salmonella percentage), treatment at pH 8.2 showed a reduction (day 1) in salmonella from 60% to 10% pre- and post-chiller. Treatment at pH 11.2 showed a reduction (day 1) in salmonella from 60% to 0% pre- and post-chiller.

Treatment at pH 11.2 showed a reduction (day 2) in salmonella from 10% to 0% pre- and post-chiller. Treatment at pH 8.2 showed a change (day 2) in salmonella from 0% to 10% pre- and post-chiller. Without being bound to any particular theory, the difference between the results in day 1 and day 2 can be due to differences in the bird populations tested on those days.

As shown in FIG. 5, day 1 testing of whole birds treated at pH 8.2 (40 ppm PAA) showed complete removal of Campylobacter between pre-chiller and post chiller stages. A significant reduction in salmonella percentage was also seen pre- and post-chiller under these conditions.

As shown in FIG. 5, day 1 testing of skin from samples treated at pH 8.2 (40 ppm PAA) resulted in reduction of Campylobacter between pre-chiller and post chiller stages. Some significant reduction in salmonella percentage was also seen pre- and post-chiller under these conditions. Reductions were also seen in APC and EB.

As shown in FIG. 6, day 1 testing of whole birds treated at pH 11.2 (40 ppm PAA) showed complete removal of Campylobacter between pre-chiller and post chiller stages. Complete reduction in salmonella percentage was also seen pre- and post-chiller under these conditions. Also as shown in FIG. 6, day 1 testing of skin from samples treated at pH 11.2 (40 ppm PAA) resulted in significant reduction of Campylobacter between pre-chiller and post chiller stages. Some significant reduction in salmonella percentage was also seen pre- and post-chiller under these conditions. Reductions were also seen in APC and EB.

As shown in FIG. 7, day 2 testing of whole birds treated at pH 8.2 (40 ppm PAA) showed complete removal of Campylobacter between pre-chiller and post chiller stages. Very little salmonella percentage was seen post-chiller under these conditions.

As shown in FIG. 7, day 2 testing of skin from samples treated at pH 8.2 (40 ppm PAA) resulted in reduction of Campylobacter between pre-chiller and post chiller stages. Very little salmonella percentage was seen post-chiller under these conditions. Reductions were also seen in APC and EB.

As shown in FIG. 8, day 2 testing of whole birds treated at pH 11.2 (40 ppm PAA) showed complete removal of Campylobacter between pre-chiller and post chiller stages. Complete reduction in salmonella percentage was also seen post-chiller under these conditions.

Also as shown in FIG. 8, day 2 testing of skin from samples treated at pH 11.2 (40 ppm PAA) resulted in significant reduction of Campylobacter between pre-chiller and post chiller stages. Significant reduction in salmonella percentage was also seen pre- and post-chiller under these conditions. Reductions were also seen in APC and EB.

### 3. Contact Angle Testing

Contact angle is the angle measured when an interaction occurs between a liquid and substrate. According to the definition, the contact angle is measured from the angle formed between substrate surface where a liquid droplet is placed and the tangent to the drop surface from the 3-phase point. By measuring this angle, one can assess wettability or wetting phenomenon, which is indicative of the adhesive contact of a liquid on a substrate. Contact angle can also provide insight into the relative chemical/physical uniformity of the substrate, sorption characteristics and the spreading dynamic of a liquid.

Contact angle and surface energy play an important role in a variety of industrial areas to determine the efficiency of the adhesion, quality of coating and printing, efficiency of wetting, and stability of a particle dispersion.

Sample compositions as below were analyzed for their contact angle when a droplet was placed onto chicken skin obtained from Tyson Foods:
Sample A pH 3.1 PAA=72 ppm
Sample B pH 10.5
Sample C pH 10.5 PAA=72 ppm
   3a. Experimental Procedure:

For a contact angle test, a 500 μL syringe was filled with liquid samples, 1 μL droplets of liquid samples were deposited on the skin surface. Movie files were recorded for 20 seconds to collect images of the droplets on the skin surface.

Five replicate contact angle measurements were taken of each liquid sample on the chicken skin surface

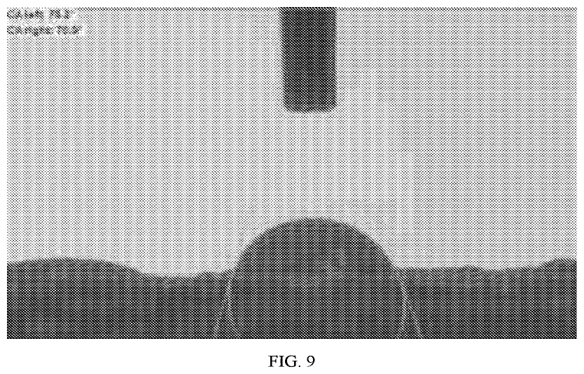

Results of average contact angle are reported in table 4 (drop age from 5 to 10 seconds) and visually represented by FIGS. 9-11.

3b. Results

TABLE 4
Contact angle, degrees of test samples on chicken skin surface

| | Contact angle, degrees of the test liquid on the chicken skin surface | |
|---|---|---|
| Sample | Mean | Standard deviation |
| Sample A, pH 3.1, | 72.8 | 1.6 |
| PAA = 72 ppm | | |
| Sample B, pH 10.5 | 63.7 | 3.2 |
| Sample C, pH 10.5, | 48.2 | 11.8 |
| PAA = 72 ppm | | |

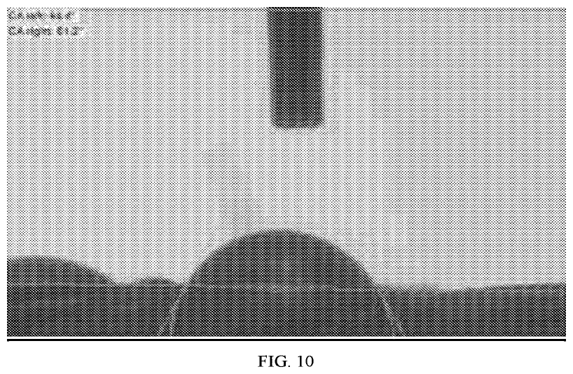

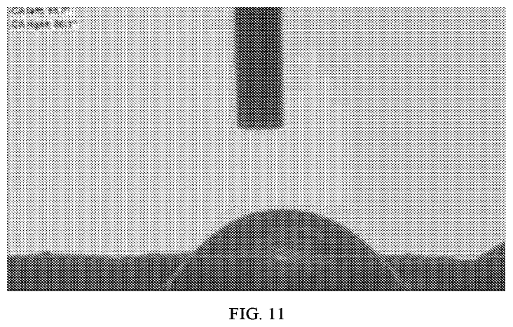

Exemplary sample contact angles are shown in FIG. 9 (sample A), FIG. 10 (sample B), and FIG. 11 (sample C).

As shown, the mean contact angle for sample C was, surprisingly, lower than the mean contact angles for either sample A or sample B. This was considered surprising, as the composition of sample C (as compared to the compositions of samples A and B) would ordinarily lead one of skill in the art to expect sample C to have a contact angle between that of sample A and that of sample B.

### Exemplary Embodiments

The following embodiments are exemplary only and do not limit the scope of the present disclosure or the appended claims.

Embodiment 1. A treatment method, comprising: in a treatment process, (a) contacting a substrate at an application region with a basic fluid having a pH of at least about 9 and with an oxidizer, or (b) contacting a substrate at an application region with a composition that comprises an oxidizer, the composition having a pH of at least about 9.

Without being bound to any particular theory, application of a composition having a pH of about 9 or higher results in favorable “wetting” of the composition across the substrate being treated, i.e., a relatively improved spreading of the composition across (and into) the substrate being treated. Again without being bound to any particular theory, this in turn gives rise to improved coverage (and penetration) of other agents that can be present, including, for example, oxidizers. This increased coverage and penetration in turn results in greater effectiveness of any treatment agents (e.g., oxidizers) that are being applied. This can give rise to, e.g., the ability to (i) achieve a given reduction in bacterial load in less time than is required to achieve that same reduction in bacterial load when using existing methods of treatment; (ii) in a given time interval, achieving a greater reduction in bacterial load than is achieved by existing methods of treatment in that same time interval; or even (iii) achieving a greater reduction in bacterial load in less time than is achieved by existing methods of treatment.

The composition that comprises an oxidizer can have a contact angle of less than about 58 degrees when contacted to chicken skin, at 101.325 kPa and 20 deg. C. For example, the composition can have a contact angle of between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin, at 101.325 kPa and 20 deg. C.

A basic fluid can also have can have a contact angle of between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin, at 101.325 kPa and 20 deg. C.

Likewise, the basic fluid and oxidizer can (singly or in combination) have a contact angle of between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin, at 101.325 kPa and 20 deg. C. The substrate can be contacted with a mixture of fluids that together have a contact angle of between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin at 101.325 kPa and 20 deg. C.

As a non-limiting example, chicken parts can be contacted with a composition that comprises an oxidizer, the composition (with oxidizer) having a pH of at least about 9, whereby the composition effects a contact angle of less than about 58 degrees when contacted to chicken skin at 101.325 kPa and 20 deg. C. As another non-limiting example, chicken parts can be contacted with a basic fluid having a pH of at least about 9 and an oxidizer, whereby the basic fluid effects a contact angle of less than about 58 degrees when contacted to chicken skin at 101.325 kPa and 20 deg. C., whereby the oxidizer effects a contact angle of less than about 58 degrees when contacted to chicken skin at 101.325 kPa and 20 deg. C., and/or whereby whereby the basic fluid and oxidizer effect a contact angle of less than about 58 degrees when contacted to chicken skin at 101.325 kPa and 20 deg. C.

Without being bound to any particular theory, the disclosed technology can also allow for achieving a given reduction in bacterial load by use of less oxidizer than is needed with existing methods of treatment to achieve that reduction in bacterial load. This can be explained by, e.g., the increasing wetting described herein allowing for greater penetration of oxidizing agent such that a relatively small amount of oxidizing agent can spread more efficiently and deeply than a relatively large amount of oxidizing agent used in conjunction with existing methods of treatment.

It should be understood that in the disclosed methods, a user can contact the substrate with a composition that itself has a pH of at least about 9 and also comprises an oxidizer. The composition can be pre-mixed at a location upstream from the application region; as one example, the composition can be formed by mixing a solution of NaOH with an oxidizer (e.g., peracetic acid (PAA)) in a chamber that is then placed into fluid communication with the application region.

It should be understood that in some embodiments, the substrate experiences a pH of greater than about 9 by virtue of the compositions to which the substrate is exposed. The substrate can experience a pH of, about 9 to about 14, or from about 9.1 to about 13.9, or from about 9.2 to about 13.8, or from about 9.3 to about 13.7, or from about 9.4 to about 13.6, or from about 9.5 to about 13.5, or from about 9.6 to about 13.4, or from about 9.7 to about 13.3, or from about 9.8 to about 13.2, or from about 9.9 to about 13.1, or from about 10 to about 13, or from about 10.1 to about 12.9, or from about 10.2 to about 12.8, or from about 10.3 to about 12.7, or from about 10.4 to about 12.6, or from about 10.5 to about 12.5, or from about 10.6 to about 12.4, or from about 10.7 to about 12.3, or from about 10.8 to about 12.2, or from about 10.9 to about 12.1, or from about 11 to about 12, or from about 11.1 to about 11.9, or from about 11.2 to about 11.8, or from about 11.3 to about 11.7, or from about 11.4 to about 11.6, or even about 11.5.

The composition can also be pre-formulated (e.g., formulated externally to a substrate treatment system) and then introduced to the application region. This introduction can be by pumps, gravity feed, and the like.

The application region can be a container, e.g., a tank, a cabinet, and the like. As one example, the application region can be a chiller tank, e.g., an immersion-type tank. The application region can also be a pre-chiller tank or even a post-chiller tank. Chiller tanks (and pre- and post-chiller tanks) are known to those in the foodstuff treatment field.

The application region can also be a spray cabinet or other spray modality. In such an embodiment, fluid can be sprayed onto (from one or more directions) the substrate being treated. As one example, fluid can be sprayed onto a substrate from above, below, and from the side or sides of the substrate.

Embodiment 2. The method of Embodiment 1, further comprising mixing the basic fluid and the oxidizer at a location upstream of the application region in the foodstuff treatment process. This can be accomplished in a variety of ways, e.g., by baffles, paddles, tortuous flow, turbulent flow, laminar flow, and the like. The mixing can be accomplished by moving parts (e.g., moving paddles), but can also be accomplished by effecting a suitable flow path for the fluids being mixed.

Embodiment 3. The method of Embodiment 1, wherein the basic fluid has a pH in the range of from about 10 to about 13. The basic fluid can have a pH of, about 9 to about 14, or from about 9.1 to about 13.9, or from about 9.2 to about 13.8, or from about 9.3 to about 13.7, or from about 9.4 to about 13.6, or from about 9.5 to about 13.5, or from about 9.6 to about 13.4, or from about 9.7 to about 13.3, or from about 9.8 to about 13.2, or from about 9.9 to about 13.1, or from about 10 to about 13, or from about 10.1 to about 12.9, or from about 10.2 to about 12.8, or from about 10.3 to about 12.7, or from about 10.4 to about 12.6, or from about 10.5 to about 12.5, or from about 10.6 to about 12.4, or from about 10.7 to about 12.3, or from about 10.8 to about 12.2, or from about 10.9 to about 12.1, or from about 11 to about 12, or from about 11.1 to about 11.9, or from about 11.2 to about 11.8, or from about 11.3 to about 11.7, or from about 11.4 to about 11.6, or even about 11.5.

Embodiment 4. The method of Embodiment 1, wherein the composition has a pH in the range of from about 10 to about 13. The composition can have a pH of, about 9 to about 14, or from about 9.1 to about 13.9, or from about 9.2 to about 13.8, or from about 9.3 to about 13.7, or from about 9.4 to about 13.6, or from about 9.5 to about 13.5, or from about 9.6 to about 13.4, or from about 9.7 to about 13.3, or from about 9.8 to about 13.2, or from about 9.9 to about 13.1, or from about 10 to about 13, or from about 10.1 to about 12.9, or from about 10.2 to about 12.8, or from about 10.3 to about 12.7, or from about 10.4 to about 12.6, or from about 10.5 to about 12.5, or from about 10.6 to about 12.4, or from about 10.7 to about 12.3, or from about 10.8 to about 12.2, or from about 10.9 to about 12.1, or from about 11 to about 12, or from about 11.1 to about 11.9, or from about 11.2 to about 11.8, or from about 11.3 to about 11.7, or from about 11.4 to about 11.6, or even about 11.5.

Embodiment 5. The treatment method of Embodiment 1, wherein the oxidizer is present at the application region at a concentration of from about 2 to about 2000 ppm. The oxidizer can be present at, e.g., from about 2 to about 2000 ppm, or from about 3 to about 1500 ppm, or from about 4 to about 1200 ppm, or from about 5 to about 1000 ppm, or from about 6 to about 900 ppm, or from about 7 to about 800 ppm, or from about 8 to about 700 ppm, or from about 9 to about 600 ppm, or from about 10 to about 500 ppm, or from about 15 to about 400 ppm, or from about 20 to about 300 ppm, or from about 20 to about 200 ppm, or even from about 20 to about 50 ppm.

Embodiment 6. The treatment method of Embodiment 5, wherein the oxidizer is present at the application region at a concentration of from about 2 to about 1500 ppm.

Embodiment 7. The treatment method of Embodiment 1, wherein the oxidizer is present in the composition at a concentration of from about 2 to about 2000 ppm. The oxidizer can be present at, e.g., from about 2 to about 2000 ppm, or from about 3 to about 1500 ppm, or from about 4 to about 1200 ppm, or from about 5 to about 1000 ppm, or from about 6 to about 900 ppm, or from about 7 to about 800 ppm, or from about 8 to about 700 ppm, or from about 9 to about 600 ppm, or from about 10 to about 500 ppm, or from about 15 to about 400 ppm, or from about 20 to about 300 ppm, or from about 20 to about 200 ppm, or even from about 20 to about 50 ppm.

Embodiment 8. The treatment method of Embodiment 7, wherein the oxidizer is present at the application region at a concentration of from about 2 to about 150 ppm.

Embodiment 9. The treatment method of any one of Embodiments 1-8, wherein the composition that comprises an oxidizer has a contact angle of below about 58 degrees, e.g., between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin, at 101.325 kPa and 20 deg. C. A basic fluid can also have can have a contact angle of less than about 58 degrees, e.g., between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin at 101.325 kPa and 20 deg. C. Likewise, the basic fluid and oxidizer can (singly or in combination, i.e., when mixed) have a contact angle of less than about 58 degrees, e.g., between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin at 101.325 kPa and 20 deg. C.

The substrate can be contacted with a mixture of fluids that together (i.e., when mixed) have a contact angle of less than about 58 degrees, e.g., between about 38 and about 58 degrees (e.g., from about 38 to about 58 degrees, from about 40 to about 56 degrees, from about 42 to about 54 degrees, from about 44 to about 52 degrees, from about 46 to about 50 degrees, or even about 48 degrees) when contacted to chicken skin at 101.325 kPa and 20 deg. C.

Embodiment 10. The treatment method of any one of Embodiments 1-9, wherein the composition has a surface tension of less than about 75 N/m. The composition can have a surface tension of between about 5 and about 75 N/m, or from about 10 to about 70 N/m, or from about 15 to about 65 N/m, or from about 20 to about 60 N/m, or from about 30 to about 50 N/m.

Embodiment 11. The treatment method of Embodiment 10, wherein the composition has a surface tension of between about 25 and about 50 N/m.

Embodiment 12. The treatment method of any one of Embodiments 1-11, wherein the basic fluid comprises sodium hydroxide, potassium hydroxide, magnesium hydroxide, calcium hydroxide, sodium hypochlorite, or any combination thereof.

Embodiment 13. The treatment method of any one of Embodiments 1-12, wherein the composition comprises sodium hydroxide, potassium hydroxide, magnesium hydroxide, calcium hydroxide, sodium hypochlorite, or any combination thereof.

The composition can also include one or more surfactants. Without being bound to any particular theory, the presence of one or more surfactants can improve the wetting characteristics of the composition. Suitable surfactants include, e.g., nonionic, anionic and/or cationic surfactant types. Some non-limiting examples of surfactants are, e.g., alcohol ethoxylates, alcohol ethoxylate carboxylate, amine oxides, alkyl sulfates, alkyl ether sulfate, sulfonates, quaternary ammonium compounds, alkyl glucosides, and fatty acids. Similarly, the disclosed methods can also include contacting the substrate with one or more surfactants (e.g., to enhance wetting); suitable surfactants are described elsewhere herein.

Embodiment 14. The treatment method of any one of Embodiments 1-13, wherein the oxidizer comprises peracetic acid (PAA), hydrogen peroxide, an inorganic peroxide, a halogen, a percarbonate, an organic persulfate, or any combination thereof. PAA is considered an especially suitable oxidizer.

Embodiment 15. The treatment method of Embodiment 14, wherein the oxidizer comprises peracetic acid.

Embodiment 16. The treatment method of any one of Embodiments 1-15, wherein the contacting is performed for from about 1 second to about 3 hours. Contacting can be performed for from, e.g., about 10 seconds to about 2 hours, or from about 30 seconds to about 1.5 hours, or from about 60 seconds to about 1 hour, or from about 90 seconds to about 45 minutes, or from about 2 minutes to about 40 minutes, or from about 3 minutes to about 35 minutes, or from about 4 minutes to about 30 minutes, or from about 5 minutes to about 25 minutes, or from about 10 minutes to about 20 minutes.

Embodiment 17. The treatment method of any one of Embodiments 1-16, wherein the contacting is performed at less than about 50 deg. F. This can be accomplished by, e.g., effecting chilling of fluids that are introduced to the application region, by chilling the application region itself, or by other techniques known to those in the art.

Embodiment 18. The treatment method of Embodiment 17, wherein the contacting is performed at between about 32 and about 80 deg. F.

Embodiment 19. The treatment method of any one of Embodiments 1-18, wherein the contacting is performed before the substrate attains a temperature of between about 32 and about 80 deg. F. As one example, this can be performed by contacting the substrate as recited herein before the substrate enters a chiller, i.e., in a pre-chiller step. Without being bound to any particular theory, this can be accomplished so as to pre-treat a substrate and reduce the substrate's bacterial load before the substrate enters a chiller.

Embodiment 20. The treatment method of any one of Embodiments 1-19, wherein the contacting is performed after the substrate attains a temperature of between about 32 and about 80 deg. F. As one example, this can be performed by contacting the substrate as recited after the substrate enters a chiller, e.g., in a post-chiller step. Without being bound to any particular theory, this can be performed to ensure that the substrate meets certain disinfection criteria following processing, e.g., as a supplemental disinfection process following a more traditional chiller step.

Embodiment 21. The treatment method of any one of Embodiments 1-20, wherein the substrate is characterized as having an initial bacterial load and wherein the contacting is effected so as to reduce the bacterial load of the substrate by at least 1 log. The contacting can be effected so as to reduce the bacterial load of the substrate by, e.g., 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4 log, or by even more. The contacting can also be effected so as to reduce the bacterial load of the substrate but, e.g., from about 1 to about 4 log, from about 1.5 to about 3.5 log, or even from about 2 to about 2.5 log.

Embodiment 22. The treatment method of Embodiment 21, wherein the substrate is characterized as having an initial bacterial load and wherein the contacting is effected so as to reduce the bacterial load of the substrate by at least 2 log.

Embodiment 23. The treatment method of any one of Embodiments 1-22, wherein the substrate is characterized as a foodstuff. Virtually any foodstuff can be processed by the disclosed methods, e.g., animal meats (including seafood), fruits, and vegetables. Poultry, pork, and red meat are considered especially suitable for the disclosed methods.

Embodiment 24. The treatment method of Embodiment 23, wherein the foodstuff comprises a fruit or vegetable.

Embodiment 25. The treatment method of Embodiment 23, wherein the foodstuff is characterized as an animal meat.

Embodiment 26. A system, the system being configured to perform the method of any one of Embodiments 1-25.

Embodiment 27. A system, comprising: an application region configured to receive a substrate for treatment; and (i) a first inlet configured to deliver to the application region a composition having a pH of at least about 9 and an oxidizer, or (ii) a first inlet configured to deliver to the application region a basic fluid having a pH of at least about 9 and a second inlet configured to deliver to an oxidizer to the application region.

Systems according to the present disclosure can include, e.g., modalities for introducing substrates to the application region and/or for removing substrates from the application region. Such modalities include, e.g., conveyors, belts (e.g., rehang belts), lines (e.g., shackle lines), and the like.

A system can also include one or more sensors adapted to measure a pH within the application region, e.g., the pH of the fluid or fluids that contact the substrate. A system can also include one or more sensors adapted to detect a level of oxidizer in a fluid or fluids that contact the substrate and/or fluids that have already contacted the substrate.

Suitable substrates, compositions, and oxidizers are described elsewhere herein. A system can configured such that the substrate experiences a pH of greater than about 9 by virtue of the compositions to which the substrate is exposed. The substrate can experience a pH of, about 9 to about 14, or from about 9.1 to about 13.9, or from about 9.2 to about 13.8, or from about 9.3 to about 13.7, or from about 9.4 to about 13.6, or from about 9.5 to about 13.5, or from about 9.6 to about 13.4, or from about 9.7 to about 13.3, or from about 9.8 to about 13.2, or from about 9.9 to about 13.1, or from about 10 to about 13, or from about 10.1 to about 12.9, or from about 10.2 to about 12.8, or from about 10.3 to about 12.7, or from about 10.4 to about 12.6, or from about 10.5 to about 12.5, or from about 10.6 to about 12.4, or from about 10.7 to about 12.3, or from about 10.8 to about 12.2, or from about 10.9 to about 12.1, or from about 11 to about 12, or from about 11.1 to about 11.9, or from about 11.2 to about 11.8, or from about 11.3 to about 11.7, or from about 11.4 to about 11.6, or even about 11.5.

Embodiment 28. The system of Embodiment 27, wherein the system comprises one or more mixing modalities in fluid communication with the application region, the one or more mixing modalities being configured to effect mixing of the basic fluid and the oxidizer and/or mixing of the composition.

Embodiment 29. The system of any one of Embodiments 27-28, wherein the basic fluid comprises sodium hydroxide, potassium hydroxide, magnesium hydroxide, calcium hydroxide, sodium hypochlorite, or any combination thereof.

Embodiment 30. The system of any one of Embodiments 27-29, wherein the composition comprises sodium hydroxide, potassium hydroxide, magnesium hydroxide, calcium hydroxide, sodium hypochlorite, or any combination thereof.

Embodiment 31. The system of any one of Embodiments 27-30, wherein the oxidizer comprises peracetic acid, hydrogen peroxide, an inorganic peroxide, a halogen, a percarbonate, an organic persulfate, or any combination thereof.

Embodiment 32. The system of any one of Embodiments 27-31, wherein the system is configured such that the oxidizer is present at the application region at a concentration of from about 2 to about 2000 ppm. The oxidizer can be present at, e.g., from about 2 to about 2000 ppm, or from about 3 to about 1500 ppm, or from about 4 to about 1200 ppm, or from about 5 to about 1000 ppm, or from about 6 to about 900 ppm, or from about 7 to about 800 ppm, or from about 8 to about 700 ppm, or from about 9 to about 600 ppm, or from about 10 to about 500 ppm, or from about 15 to about 400 ppm, or from about 20 to about 300 ppm, or from about 20 to about 200 ppm, or even from about 20 to about 50 ppm.

Embodiment 33. The system of Embodiment 32, wherein the system is configured such that the oxidizer is present at the application region at a concentration of from about 2 to about 150 ppm.

Embodiment 34. The system of any one of Embodiments 27-33, wherein the application region is configured to contact the substrate by way of a spray, a dip, a stream, a curtain, or any combination thereof with (i) the composition or (ii) the basic fluid and the oxidizer.

Embodiment 35. The system of any one of Embodiments 27-34, wherein the system is configured to contact the substrate with the second fluid by way of a spray, a dip, a stream, a curtain, or any combination thereof.

Embodiment 36. The system of any one of Embodiments 27-35, the system being configured to modulate the duration of the substrate's exposure to the composition, to the basic fluid, to the oxidizer, or any combination thereof.

Embodiment 37. A system, comprising: a first application region configured to receive a substrate for treatment; a first inlet configured to deliver to the first application region a composition having a pH of at least about 9; a second application configured to receive the substrate for treatment; and a second inlet configured to deliver an oxidizer to the second application region.

Suitable substrates, compositions, and oxidizers are described elsewhere herein.

A system can configured such that the substrate experiences a pH of greater than about 9 by virtue of the compositions to which the substrate is exposed. The substrate can experience a pH of, about 9 to about 14, or from about 9.1 to about 13.9, or from about 9.2 to about 13.8, or from about 9.3 to about 13.7, or from about 9.4 to about 13.6, or from about 9.5 to about 13.5, or from about 9.6 to about 13.4, or from about 9.7 to about 13.3, or from about 9.8 to about 13.2, or from about 9.9 to about 13.1, or from about 10 to about 13, or from about 10.1 to about 12.9, or from about 10.2 to about 12.8, or from about 10.3 to about 12.7, or from about 10.4 to about 12.6, or from about 10.5 to about 12.5, or from about 10.6 to about 12.4, or from about 10.7 to about 12.3, or from about 10.8 to about 12.2, or from about 10.9 to about 12.1, or from about 11 to about 12, or from about 11.1 to about 11.9, or from about 11.2 to about 11.8, or from about 11.3 to about 11.7, or from about 11.4 to about 11.6, or even about 11.5.

### Summary of Advantages

Thus, the presently disclosed technology provides a number of advantages over existing approaches:
Improved wetting and/or penetration of active agent into substrate
Preservation of fatty tissues in substrate so as to maintain pleasing textures
Lower volatiles, and lower usage rate resulting in improved safety and cost reduction (reduced consumption in both chemical and water)

The foregoing evaluation demonstrates that the presently disclosed technology is well-suited to applications where there are certain constraints on the vapor or other exposure levels of a particular chemical agent or chemical agents, as the disclosed technology can give rise to significant reductions in the levels of such vapors while at the same time allowing the user to maintain the necessary concentrations of the chemical agent in the process fluid.

As described herein, an embodiment of the disclosed technology can be configured so as to achieve one or more regulatory performance standards. The disclosed technology can be configured to comply with certain sanitation performance criteria while also maintaining certain chemical agent vapor performance criteria related to vapor exposure.

What is claimed:

1. A treatment method,
comprising: in a treatment process,
(a) contacting a foodstuff substrate at an application region with a basic fluid having a pH of at least about 9 and with an oxidizer, or
(b) contacting a foodstuff substrate at an application region with a composition that comprises an oxidizer, the composition having a pH of at least about 9.

2. The method of claim 1, further comprising mixing the basic fluid and the oxidizer at a location upstream of the application region in the treatment process.

3. The method of claim 1, wherein the basic fluid has a pH in the range of from about 10 to about 13.

4. The method of claim 1, wherein the composition has a pH in the range of from about 10 to about 13.

5. The treatment method of claim 1, wherein the oxidizer is present at the application region at a concentration of from about 2 to about 2000 ppm.

6. The treatment method of claim 5, wherein the oxidizer is present at the application region at from about 20 ppm to about 200 ppm.

7. The treatment method of claim 1, wherein the oxidizer is present in the composition at a concentration of from about 2 to about 2000 ppm.

8. The treatment method of claim 6, wherein the oxidizer is present in the composition at from about 20 ppm to about 50 ppm.

9. The treatment method of claim 1, wherein the composition that comprises the oxidizer has a contact angle of below about 58 degrees, wherein the basic fluid has a contact angle of below about 58 degrees, wherein the basic fluid and oxidizer have a contact angle of below about 58 degrees, or any combination thereof.

10. The treatment method of claim 1, wherein the composition has a surface tension of less than about 75 Nim.

11. The treatment method of claim 10, wherein the composition has a surface tension of between about 25 and about 50 Nim.

12. The treatment method of claim 1, wherein the basic fluid comprises sodium hydroxide, potassium hydroxide, magnesium hydroxide, calcium hydroxide, sodium hypochlorite, or any combination thereof.

13. The treatment method of claim 1, wherein the composition comprises sodium hydroxide, potassium hydroxide, magnesium hydroxide, calcium hydroxide, sodium hypochlorite, or any combination thereof.

14. The treatment method of claim 1, wherein the oxidizer comprises peracetic acid, hydrogen peroxide, an inorganic peroxide, a halogen, a percarbonate, an organic persulfate, or any combination thereof.

15. The treatment method of claim 1, wherein the contacting is performed at less than about 50 deg. F.

16. The treatment method of claim 1, wherein the contacting is performed at between about 32 and about 80 deg. F.

17. The treatment method of claim 1, wherein the foodstuff substrate comprises a fruit or vegetable.

18. The method of claim 1, wherein the foodstuff substrate is characterized as an animal meat.

19. The method of claim 1, wherein the foodstuff substrate experiences a pH in a range of about 10.1 to about 12.9 in the application region.

20. The method of claim 1, wherein the foodstuff substrate experiences a pH of greater than 10.1 in the application region.
